(19) United States
(12) Patent Application Publication
(10) Pub. No.: US 2026/0101295 A1
(43) Pub. Date: Apr. 9, 2026

(54) TECHNIQUES FOR INDICATING ON-DEMAND SYNCHRONIZATION SIGNAL BLOCK PARAMETERS

(71) Applicant: Lenovo (United States) Inc., Morrisville, NC (US)

(72) Inventors: Alexander Golitschek Edler von Elbwart, Darmstadt (DE); Prateek Basu Mallick, Dreieich (DE); Joachim Löhr, Wiesbaden (DE)

(21) Appl. No.: 18/905,536

(22) Filed: Oct. 3, 2024

(51) Int. Cl. H04W 56/00; H04W 72/231; H04W 74/0833

(52) U.S. Cl. CPC H04W 56/0015; H04W 72/231; H04W 74/0833

(57) ABSTRACT

Various aspects of the present disclosure relate to receiving a synchronization signal block (SSB) configuration comprising a set of one or more parameters, wherein a parameter of the set of one or more parameters is associated with a plurality of values. Aspects of the present disclosure relate to receiving a first message comprising at least one identifier.

Aspects of the present disclosure relate to determining a parameter and a value for the parameter based at least in part on the at least one identifier, wherein the value corresponds to one of the plurality of values. Aspects of the present disclosure relate to receiving an SSB transmission based at least in part on the determined parameter and the determined value for the determined parameter.

### TECHNICAL FIELD

The present disclosure relates to wireless communications, and more specifically to techniques for indicating (e.g., signaling, providing, communicating) one or more parameters for an on-demand synchronization signal block (SSB).

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. ” Further, as used herein, including in the claims, a “set” may include one or more elements.

Some implementations of the method and apparatuses described herein may receive a SSB configuration comprising a set of one or more parameters, wherein a parameter of the set of one or more parameters is associated with a plurality of values; receive a first message comprising at least one identifier; determine a parameter and a value for the respective parameter based at least in part on the at least one identifier, wherein the value corresponds to one of the plurality of values; and receive an SSB transmission based at least in part on the determined parameter and the determined value for the determined parameter.

Other implementations of the method and apparatuses described herein may transmit a SSB configuration comprising a set of one or more parameters, wherein a parameter of the set of one or more parameters is associated with a plurality of values; determine, for a serving cell, a parameter and a value for the parameter, wherein the value corresponds to one of the plurality of values; and transmit a first message comprising at least one identifier to a user equipment (UE), wherein the at least one identifier indicates the value for the parameter.

### BRIEF DESCRIPTION OF THE DRAWINGS

FIG. 1 illustrates an example of a wireless communications system in accordance with aspects of the present disclosure.

FIG. 2 illustrates an example of a protocol stack, in accordance with aspects of the present disclosure.

FIG. 3 illustrates an example of an SSB burst comprising multiple SSB transmissions, in accordance with aspects of the present disclosure.

FIG. 4A illustrates an example of an abstract syntax notation #1 (ASN.1) structure for a configuration information element (IE) for on-demand SSB, in accordance with aspects of the present disclosure.

FIG. 4B illustrates another example of an ASN.1 structure for a configuration IE for on-demand SSB, in accordance with aspects of the present disclosure.

FIG. 4C illustrates another example of an ASN.1 structure for a configuration IE for on-demand SSB, in accordance with aspects of the present disclosure.

FIG. 5A illustrates an example of another ASN.1 structure for a configuration IE for on-demand SSB, in accordance with aspects of the present disclosure.

FIG. 5B illustrates another example of an ASN.1 structure for a configuration IE for on-demand SSB, in accordance with aspects of the present disclosure.

FIG. 6 illustrates an example of a medium access control (MAC) control element (MAC-CE) including a selection identifier (ID) field in accordance with aspects of the present disclosure.

FIG. 7 illustrates an example of a MAC-CE including a selection ID field and a target field in accordance with aspects of the present disclosure.

FIG. 8 illustrates an example of a MAC-CE including a selection ID field and a secondary cell (SCell) index field in accordance with aspects of the present disclosure.

FIG. 9 illustrates an example of a MAC-CE including a plurality of selection ID fields in accordance with aspects of the present disclosure.

FIG. 10 illustrates an example of a MAC-CE including a selection ID field and a parameter ID field in accordance with aspects of the present disclosure.

FIG. 11 illustrates another example of a MAC-CE including a plurality of selection ID fields in accordance with aspects of the present disclosure.

FIG. 12 illustrates an example of a UE in accordance with aspects of the present disclosure.

FIG. 13 illustrates an example of a processor in accordance with aspects of the present disclosure.

FIG. 14 illustrates an example of a network equipment (NE) in accordance with aspects of the present disclosure.

FIG. 15 illustrates a flowchart of a method performed by a UE in accordance with aspects of the present disclosure.

FIG. 16 illustrates a flowchart of a method performed by a NE in accordance with aspects of the present disclosure.

### DETAILED DESCRIPTION

In a wireless communications system, UEs and/or NEs may be configured to or operable to support one or more energy saving techniques. In some examples, a UE and/or a NE (e.g., a base station) may operate according to one or more modes, each mode yielding a different power consumption for the UE and/or the NE including. Examples of modes include, but are not limited to, an inactive mode, an idle mode, and an active mode. In the inactive mode or the idle mode, the UE and/or the NE can refrain from actively performing wireless communication (e.g., transmitting and receiving) and/or other operations (e.g., monitoring, detecting) related to the wireless communication, yielding power savings the UE and/or the NE. The power savings may result from reduced usage of the circuitry (e.g., components) in the UE and/or the NE for the wireless communication and/or related operations. Put another way, the circuitry (e.g., components) in the UE and/or the NE may be powered OFF or switched (e.g., transitioned) to a low power state. In the active mode, the UE and/or the NE may perform wireless communication, yielding a higher power consumption compared to the inactive mode and the idle mode, as the circuity in the UE and/or the NE may be powered ON too support the wireless communication and related operations (e.g., transmit, encode, modulate, receive, decode, demodulate, etc.).

UEs and/or NEs may be configured to or operable to perform one or more random access procedure to establish, maintain, and/or reestablish a connection. A NE (e.g., base station) may transmit, to a UE, a synchronization signal and physical broadcast channel (SS/PBCH) (also referred to as an SSB), enabling the UE to identify the base station, achieve synchronization, and receive other system information for initial access (e.g., to establish a connection with the NE). While SS/PBCH transmission is essential for initial access, it significantly increases energy consumption by the NE (also referred to as network energy consumption). In some cases, the NE may waste power performing SS/PBCH transmissions, such as when no UE is attempting to access the cell associated with the NE. Additionally, emissions and energy consumption from various entities (e.g., UE, NE, or other network entities) of the wireless communication system are negatively impacting the climate.

To reduce emissions, lower energy consumption, and decrease operating costs, NE (e.g., one or more cells) may operate in a network energy saving mode. Under this mode, the NE may transmit an SSB on-demand. The on-demand SSB may be associated with one or more parameters, such as a periodicity of an SSB transmission, a transmit power of the SSB transmission, etc. The present disclosure provides one or more solutions to the network energy consumption problems by enabling a NE to efficiently transmit (e.g., provision) one or more parameters (also referred to as on-demand SSB parameters) associated with on-demand SSB. Additionally, a set of values may be configured for the one or more on-demand SSB parameters. The NE may transmit, and a UE may receive, an indication of a current value of an on-demand SSB parameter, as described herein.

Aspects of the present disclosure describe new signaling solutions and behaviors for indicating parameter values for on-demand SSB transmission on a cell. Aspects of the present disclosure are described in the context of a wireless communications system.

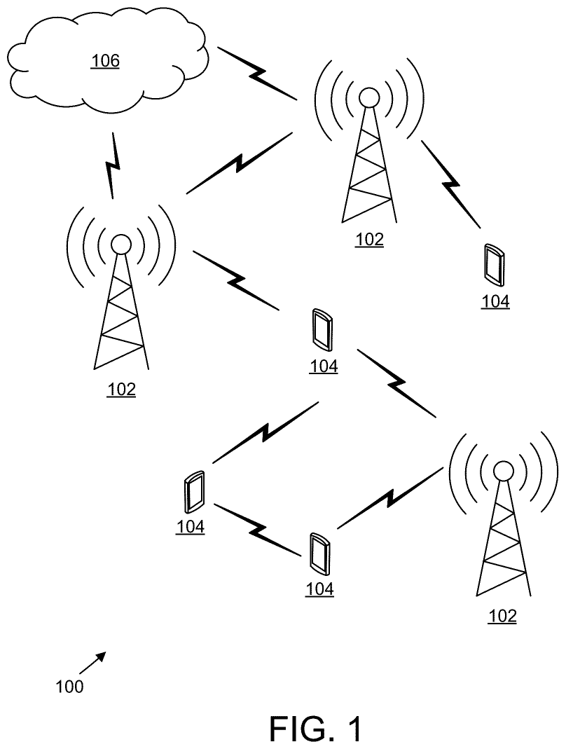

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network.

In other implementations, the wireless communications system 100 may be a combination of a 4G network and a 5G network, or other suitable radio access technology (RAT) including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N3, or network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, N3, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings (SCS) of 15 kHz, 30 kHz, 60 kHz, 120 kHz, and 240 kHz may utilize a single slot per subframe, two slots per subframe, four slots per subframe, eight slots per subframe, and 16 slots per subframe, respectively.

Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

For initial access, a UE 104 detects a candidate cell and performs downlink (DL) synchronization. For example, the gNB (e.g., an embodiment of the NE 102) may transmit a SS/PBCH transmission, also referred to as an SSB. The synchronization signal is a predefined data sequence known to the UE 104 (or derivable using information already stored at the UE 104) and is in a predefined location in time relative to frame/subframe boundaries, etc. The UE 104 searches for the SSB and uses the SSB to obtain DL timing information (e.g., symbol timing) for the DL synchronization. The UE 104 may also decode system information (SI) based on the SSB. Note that with beam-based communication, each DL beam may be associated with a respective SSB.

After performing DL synchronization and acquiring essential SI, such as the master information block (MIB) and the system information block (SIB) type 1 (SIB1), the UE 104 performs uplink (UL) synchronization and resource request by performing a random-access procedure, referred to as “RACH procedure” by selecting and transmitting a preamble on the physical random access channel (PRACH). The PRACH preamble is transmitted during a random access channel (RACH) occasion, i.e., a predetermined set of time-frequency resources that are available for the reception of the PRACH preamble. Note that with beam-based communication, the UE 104 may select a certain DL beam and transmit the PRACH preamble on a corresponding UL beam. In such embodiments, there may be a mapping between SSB and RACH occasion, allowing the network to determine which beam the UE 104 has selected.

Regarding random access, two types of RACH procedure are supported in a Third Generation Partnership Project (3GPP) wireless communication network: A) a 4-step random-access (RA) type initiated by the sending of a RACH message 1 (Msg1) and 2-step RA type with RACH message A (MsgA). Both types of RACH procedure support contention-based random access (CBRA) and contention-free random access (CFRA).

The UE 104 selects the RA type at the initiation of the RACH procedure, e.g., based on network configuration. In one example, when CFRA resources are not configured, a reference signal received power (RSRP) threshold is used by the UE 104 to select between 2-step RA type and 4-step RA type. In another example, when CFRA resources for 4-step RA type are configured, the UE 104 performs random access with 4-step RA type. In another example, when CFRA resources for 2-step RA type are configured, the UE 104 performs random access with 2-step RA type.

Note that the network does not configure CFRA resources for 4-step and 2-step RA types at the same time for a bandwidth part (BWP). Additionally, the CFRA with 2-step RA type is only supported for handover. Note that a BWP refers to a particular subset of the overall channel bandwidth within a carrier, allowing for flexible and efficient use of the frequency resources within the carrier. For example, the NE 102 may dynamically enable a respective BWP based on user demand and/or network conditions. In some examples, the BWP may consist of at least one DL BWP and at least one UL BWP.

The Msg1 of the 4-step RA type consists of a preamble transmitted on a PRACH. After the Msg1 transmission, the UE 104 monitors for a response from the network within a configured window. For CFRA, a dedicated preamble for Msg1 transmission is assigned by the network and upon receiving a random access response (RAR) from the network, the UE 104 ends the random access procedure. For CBRA, upon reception of the RAR, the UE 104 sends a RACH message 3 (Msg3) using a UL grant scheduled in the RAR and monitors for contention resolution. If contention resolution is not successful after Msg3 (re)transmission(s), then the UE 104 goes back to Msg1 transmission.

The MsgA of the 2-step RA type includes a preamble on the PRACH and a payload on a physical uplink shared channel (PUSCH). After the MsgA transmission, the UE 104 monitors for a response from the network within a configured window. For CFRA, a dedicated preamble and PUSCH resource are configured for MsgA transmission and upon receiving the network response, the UE 104 ends the random access procedure. For CBRA, if contention resolution is successful upon receiving the network response, then the UE 104 ends the random access procedure; however, if a fallback indication is received in a RACH message B (MsgB), the UE 104 performs Msg3 transmission using the UL grant scheduled in the fallback indication and monitors for contention resolution. If contention resolution is not successful after Msg3 (re)transmission(s), the UE 104 goes back to MsgA transmission.

If the random access procedure with 2-step RA type is not completed after a number of MsgA transmissions, the UE 104 can be configured to switch to CBRA with 4-step RA type.

In 3GPP NR, the gNB may transmit the maximum 64 SSBs and the maximum 64 corresponding copies of physical downlink control channel (PDCCH) and/or physical downlink shared channel (PDSCH) for delivery of SIB1 in high frequency bands (e.g., 28 GHz). This may cause significant network energy consumption even for a very low traffic load condition. According to 3GPP Technical Report (TR) 38.864 (v18.1.0), for network energy savings, a cell may support on-demand SSB and/or SIB1 (SSB/SIB1) transmissions. For example, when a cell is in a long period of cell inactivity, a UE 104 served by the cell can trigger on-demand SSB/SIB1 transmissions by sending a request to the cell.

According to implementations, one or more of the NEs 102 and the UEs 104 are operable to implement various aspects of the techniques described with reference to the present disclosure.

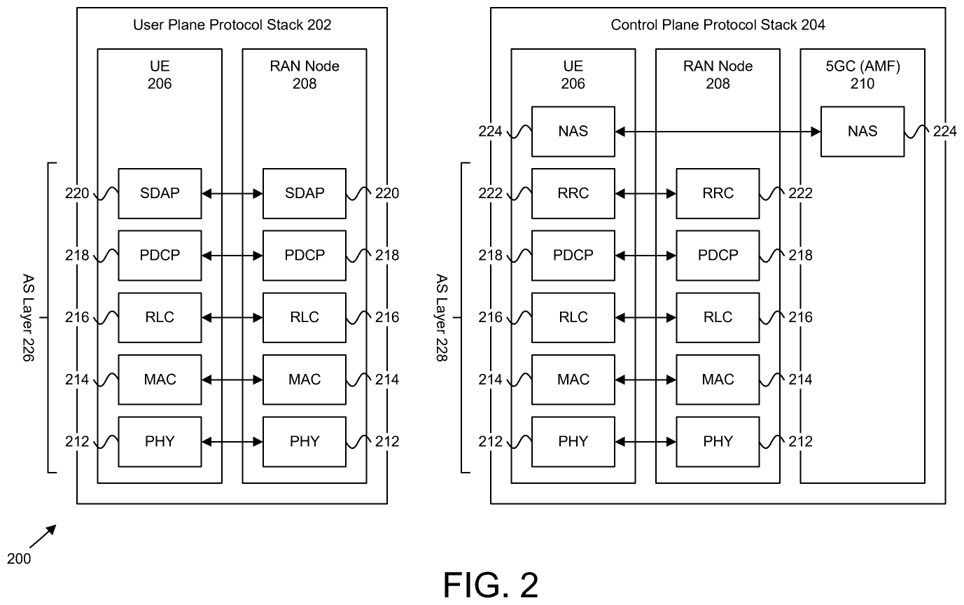

FIG. 2 illustrates an example of a protocol stack 200, in accordance with aspects of the present disclosure. While FIG. 2 shows a UE 206, a RAN node 208, and a 5GC 210 (e.g., comprising at least an AMF), these are representative of a set of UEs 104 interacting with an NE 102 (e.g., base station) and a CN 106. As depicted, the protocol stack 200 comprises a user plane protocol stack 202 and a control plane protocol stack 204. The user plane protocol stack 202 includes a physical (PHY) layer 212, a MAC sublayer 214, a radio link control (RLC) sublayer 216, a packet data convergence protocol (PDCP) sublayer 218, and a service data adaptation protocol (SDAP) sublayer 220. The control plane protocol stack 204 includes a PHY layer 212, a MAC sublayer 214, a RLC sublayer 216, and a PDCP sublayer 218. The control plane protocol stack 204 also includes a radio resource control (RRC) layer 222 and a NAS layer 224.

The AS layer 226 (also referred to as “AS protocol stack”) for the user plane protocol stack 202 consists of at least SDAP, PDCP, RLC and MAC sublayers, and the physical layer. The AS layer 228 for the control plane protocol stack 204 consists of at least RRC, PDCP, RLC and MAC sublayers, and the physical layer. The layer-1 (L1) includes the PHY layer 212. The layer-2 (L2) is split into the SDAP sublayer 220, PDCP sublayer 218, RLC sublayer 216, and MAC sublayer 214. The layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 manages the addition, modification, and release of carrier aggregation and/or dual connectivity. The RRC layer 222 also manages the establishment, configuration, maintenance, and release of signaling radio bearers (SRBs) and data radio bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as transport blocks (TBs)) from MAC service data units (SDUs) received through logical channels, and the MAC sublayer 214 in the receiving side recovers MAC SDUs from MAC PDUs received through transport channels.

In the radio protocol architectures described herein, the term “SDU” refers to a data unit that is received by a sublayer from a higher sublayer, or that is sent by a sublayer to a higher sublayer. Likewise, the term “PDU” refers to a data unit that is sent by a sublayer to a lower sublayer, or that is received by a sublayer from a lower sublayer.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as UL or DL. Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., adaptive modulation and coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of physical resource blocks (PRBs), etc.

In some embodiments, the protocol stack 200 may be an NR protocol stack used in a 5G NR system. Note that an LTE protocol stack comprises similar structure to the protocol stack 200, with the differences that the LTE protocol stack lacks the SDAP sublayer 220 in the AS layer 226, that an EPC replaces the 5GC 210, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in multiple-input multiple-output (MIMO) communication (also referred to as a “MIMO layer”or a “data stream”).

In some examples, a NE and a UE can transmit and receive signaling, such as control signaling and/or data. The NE and the UE can transmit and receive the signaling via one or more communication links. For example, the NE can transmit signaling to the UE via a DL communication link, while the UE can transmit signaling to the NE via an UL communication link. The signaling can occupy one or more time-frequency resources, which can also be referred to as communication resources or resources. For example, the NE and/or the UE can transmit signaling using one or more radio frames. A radio frame can be further divided into smaller units of time, such as slots or occasions. The NE and/or the UE can transmit the signaling using one or more frequency resources, including, but not limited to, frequency bands, component carriers (CCs), bandwidth parts (BWPs), among other example frequency resources.

In some examples, a NE and/or a UE can operate according to one or more modes or operation states. For example, a UE may implement discontinuous reception (DRX) techniques to reduce a power consumption at the UE. DRX is a technique used to conserve power by allowing a receiver of the UE to enter a sleep mode or other low-power state during time periods when the UE is not expecting incoming data (e.g., inactive periods). By avoiding reception during inactive periods, DRX reduces power consumption at the UE, extending battery life and conserving energy.

In some examples, reducing power consumption at the UE and/or the NE can reduce emissions by the UE and/or the NE, as well as reduce an operating expense related to implementing UEs and NEs with a continued rise in mobile data traffic (e.g., 6.4 gigabytes (GB) per user per month, which is forecast to grow threefold on a per-user basis over the next five years). In some cases, 5G NR improved energy-efficiency per GB over previous generations of mobility. However, new 5G use cases and the adoption of millimeter Wave (mm-Wave) communications may cause an increase in NEs to serve UEs over a geographic coverage area, leading to higher emissions.

Network energy saving can lead to environmental sustainability by reducing environmental impact (e.g., greenhouse gas emissions) and can reduce operational cost. As 5G is becoming pervasive across industries and geographical areas, handling more advanced services and applications that use relatively high data rates (e.g., greater than a threshold data rate, including extended reality (XR) related data), networks are becoming denser, use more antennas, have an increase in bandwidths, and more frequency bands.

In some examples, the energy cost on a mobile network accounts for a relatively large amount of (e.g., 23%) of a total operator cost. The NEs and other devices in a RAN account for a relatively large amount (e.g., most) of the energy consumption, such as from an active antenna unit (AAU), with data centers and fiber transport accounting for a relatively small share. The power consumption of a RAN can be split into two components, including a dynamic power consumption component, where power is consumed when data transmission and/or reception is ongoing, and a static power consumption component, where power is constantly consumed to maintain the operation of the devices in the RAN, e.g., even when the data transmission and/or reception is not on-going.

A NE expends substantial energy (e.g., greater than a threshold power consumption) to transmit signaling, including, but not limited to, SSBs, physical broadcast channels (PBCHs) that include a MIB, one or more system SIBs, and/or other system information and paging messages. The NE can transmit SSBs and SIBs (e.g., a SIB1) for cell identification, idle mode mobility, connected mode mobility, etc.

For example, the NE can periodically broadcast one or more SSBs to UEs within a coverage area of the NE. The SSBs include information for the UEs to perform time and frequency synchronization with the NE for reception of system information (e.g., the SIB1). A PBCH can include a MIB that indicates a system frame number (SFN), a subcarrier spacing, a bandwidth, among other information for reception of a SIB1. After decoding the MIB, the UE uses the information contained in the MIB to monitor the PDCCH, which, among other information, provides the scheduling information (i.e., time-frequency resources) for acquiring SIB1 in the PDSCH. Additionally, the SIB1 can indicate one or more time-frequency resources that include paging messages. The paging messages notify a UE in an inactive mode or idle mode of an incoming transmission (e.g., a data transmission).

To reduce the emissions and energy consumption, and also to reduce operating costs, one or more cells may operate in a network energy saving mode where the SSB is transmitted on-demand. In certain embodiments, the on-demand SSB may be associated with various parameters, such as periodicity of the SSB transmissions, transmit power of the SSB transmission, etc. In some examples, the on-demand SSB operation of an SCell may be triggered by gNB. Once an on-demand SSB is triggered, its transmission is in a periodic manner.

For initial access, a UE (e.g., an embodiment of the UE 104 or the UE 206) detects a candidate cell and performs DL synchronization. For example, the gNB (e.g., an embodiment of the NE 102 or the RAN node 208) may transmit a SS/PBCH transmission, also referred to as an SSB. The synchronization signal is a predefined data sequence known to the UE (or derivable using information already stored at the UE) and is in a predefined location in time relative to frame/subframe boundaries, etc. The UE searches for the SSB and uses the SSB to obtain DL timing information (e.g., symbol timing) for the DL synchronization. The UE may also decode system information (SI) based on the SSB. Note that with beam-based communication, each DL beam may be associated with a respective SSB.

During the DL synchronization step, the gNB transmits a SSB burst, e.g., periodically. The UE measures and then selects the Tx and Rx beam pair indices associated with the best SSB, where SSB consists of the primary synchronization signal (PSS), the secondary synchronization signal (SSS), and the PBCH (e.g., carrying the MIB). In certain embodiments, the UE uses the PSS to synchronize in the frequency domain and uses the SSS to synchronize in the time domain. In certain embodiments, the PBCH carries basic system information needed for the UE to begin communicating with the gNB. Additionally, the gNB transmits SIB1 to indicate the RACH resources. The UE determines RACH occasion (RO) resources, e.g., via decoding the SIB1.

After performing DL synchronization and acquiring essential SI, such as the MIB and the SIB1, the UE performs UL synchronization and resource request by performing a random-access procedure, referred to as “RACH procedure.” During the UL synchronization step, the UE first selects a RACH preamble from the configured preamble pool associated with the selected SSB Tx beam and transmits a PRACH message (Msg1 or MsgA) using the identified SSB Rx beam over one or more of the ROs associated with the selected SSB Tx beam index.

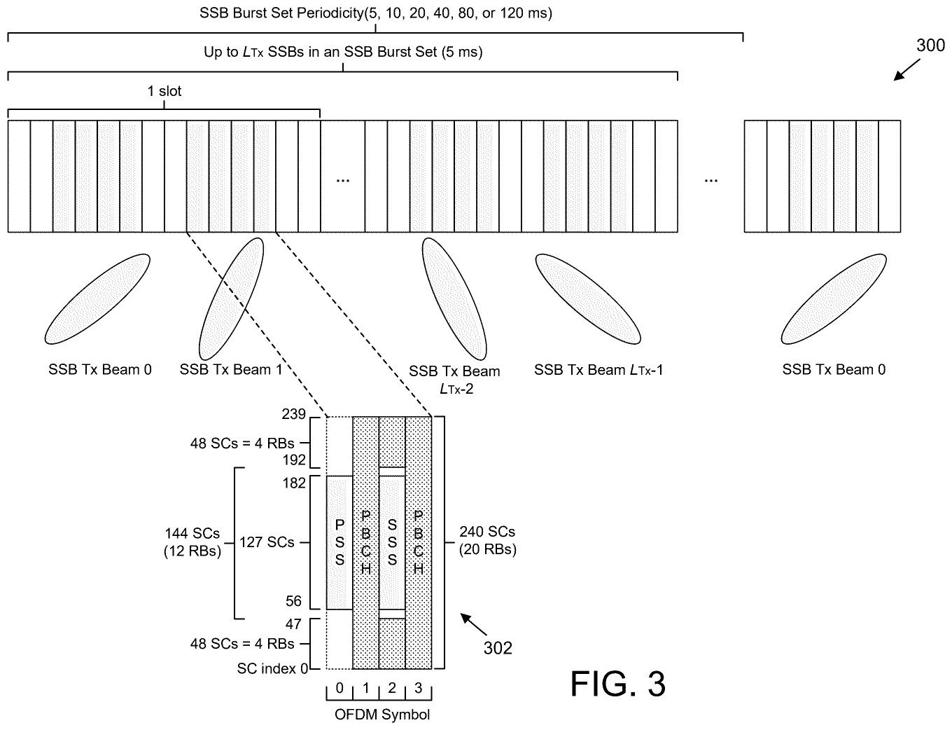

FIG. 3 illustrates an example of an SSB burst set 300 comprising multiple SSB transmissions, in accordance with aspects of the present disclosure. For example, the gNB may transmit the SSB burst set 300 with a periodicity, such as 5 ms, 10 ms, 20 ms, 40 ms, 80 ms, or 160 ms. Alternatively, the periodicity may be expressed in terms of slots, i.e., {5, 10, 20, 40, 80, 160} slots. There are up to L_{TX} SSBs in the SSB burst set 300, each associated with a different one of the L_{TX} DL beams.

A respective SSB transmission 302 (also referred to as a SS/PBCH transmission) includes the PSS, the SSS, and the PBCH. In the depicted embodiment, the SSB transmission duration is 4 OFDM symbols in the time domain, with the PSS and SSS each transmitted over 1 OFDM symbol, and the PBCH transmitted over 3 OFDM symbols.

In 5G NR, the SSB transmission 302 spans 240 subcarriers in the frequency domain. The PSS and SSS span 127 subcarriers at the center of the SSB transmission 302. In the second and fourth OFDM symbols, the PBCH spans 240 subcarriers, while in the third OFDM symbol, the PBCH covers the 48 lowest subcarriers and the 48 highest subcarriers of the SSB transmission 302.

In 5G NR, the resource block (RB) typically spans 12 subcarriers, and the bandwidth of the RB depends on the SCS used in the 5G NR system. For example, for 15 kHz SCS, the bandwidth of one RB is 180 kHz, while for 30 kHz SCS, the bandwidth of one RB is 360 kHz. Similarly, for 60 kHz SCS, the bandwidth of one RB is 720 kHz, while for 120 kHz SCS, the bandwidth of one RB is 1.44 MHz.

The duration of an RB in time is one slot, which may be composed of, e.g., 14 OFDM symbols in the time domain. In 5G NR, the time duration of an RB is based on the slot duration, which may vary according to the numerology and SCS used. For example, for 15 kHz SCS, the time duration of one RB (i.e., slot duration) is 1 ms, while for 30 kHz SCS, the time duration of one RB (slot duration) is 0.5 ms. Similarly, for 60 kHz SCS, the time duration of one RB (i.e., slot duration) is 0.25 ms, while for 120 kHz SCS, the time duration of one RB (slot duration) is 0.125 ms.

For 5G NR, the starting symbols and number of SSB blocks as function of system carrier frequency and SCS are defined in 3GPP technical specification (TS) 38.213.

For a cell supporting on-demand SSB SCell operation, the RAN may support RRC-based signaling to indicate on-demand SSB transmission on the cell. In one example, the primary cell (PCell) may transmit an RRC configuration to the UE. In another example, the RRC configuration may be transmitted by an SCell that is already activated for the UE.

Additionally, the RAN may support MAC-CE based signaling to indicate on-demand SSB transmission on the cell. In one example, the PCell may transmit the MAC-CE signaling to the UE, where the MAC-CE indicates particular values for the on-demand SSB transmission.

The parameters related to on-demand SSB transmission which may be configured via higher layer RRC signaling may include: i) frequency domain positions of the on-demand SSB; ii) SSB time domain positions within an on-demand SSB burst (e.g., using signaling similar to ssb-PositionsInBurst); and/or iii) a periodicity of the on-demand SSB.

Additionally, the following parameters for on-demand SSB may be known to UE (e.g., configured, pre-configured, or pre-defined by specification): i) sub-carrier spacing of the on-demand SSB; ii) physical cell ID (PCID) of the on-demand SSB; iii) a location of on-demand SSB burst; and/or iv) a DL transmit power of the on-demand SSB.

Moreover, in various embodiments for a cell supporting on-demand SSB SCell operation, RRC-based signaling may be used to indicate on-demand SSB transmission on the cell at least for the case where this RRC also configures the SCell, activates the SCell, and provides on-demand SSB configuration. As indicated above, MAC-CE based signaling may then indicate on-demand SSB transmission on the cell.

To improve network energy savings, the present disclosure describes a signaling design whereby an RRC message for a SCell may configure multiple candidate values at least for the periodicity of on-demand SSB transmission, where a MAC-CE can indicate the applicable value. In certain embodiments, the RRC signaling and/or MAC-CE signaling uses group-common messages to indicate values for one or more parameters for on-demand SSB transmission. In certain embodiments, the RRC signaling and/or MAC-CE signaling uses UE-specific messages to indicate values for one or more parameters for on-demand SSB transmission. In certain embodiments, the RRC signaling and/or MAC-CE signaling uses both group-common messages and UE-specific messages to indicate values for one or more one or more parameters for on-demand SSB transmission.

In some embodiments, a UE determines whether an indication in a MAC-CE refers to a group-common RRC configuration message or to a UE-specific RRC configuration. For example, the determination may be based on a radio network temporary identifier (RNTI) associated with the MAC-CE, an explicit field in the MAC-CE, or an explicit field in control information associated with the MAC-CE.

According to aspects of a first solution, the RRC configuration for on-demand SSB transmission on a cell may be facilitated by the gNB transmitting an information element that can be common to at least a group of UEs in a cell (or specifically to all UEs in a cell) or that is dedicated to a single UE (though the same dedicated configuration may be given to multiple UEs). In some embodiments, the RRC configuration includes one or more on-demand SSB periodicity values.

While on-demand SSB periodicity is described as prime example of a parameter for on-demand SSB, the aspects described herein also apply to other parameters for on-demand SSB. Moreover, the same principles may also apply to other configuration elements for which RRC signaling is used to configure a plurality of candidate values, and the selection of a particular value is indicated using MAC-CE based signaling, for example an expiry time (for how much time is the SSB transmitted (e.g., 5/10/20/40/80/160/320 ms or slots), or the SCS value of the SSB transmission (e.g., 15/30/60/120/240/480/960 kHz), the transmission power of the SSB transmission, or the BWP index for the SSB transmission. In all these instances the MAC-CE may include an identifier associated with a particular value.

For situations where more than one on-demand SSB periodicity value is included in the configuration, each such value may be implicitly or explicitly associated with an on-demand SSB configuration ID. For example, an implicit on-demand SSB configuration ID may be derived from the order of the candidate values, such as the first periodicity value is associated with on-demand SSB configuration ID_1, the second periodicity value is associated with on-demand SSB configuration ID_2, etc.

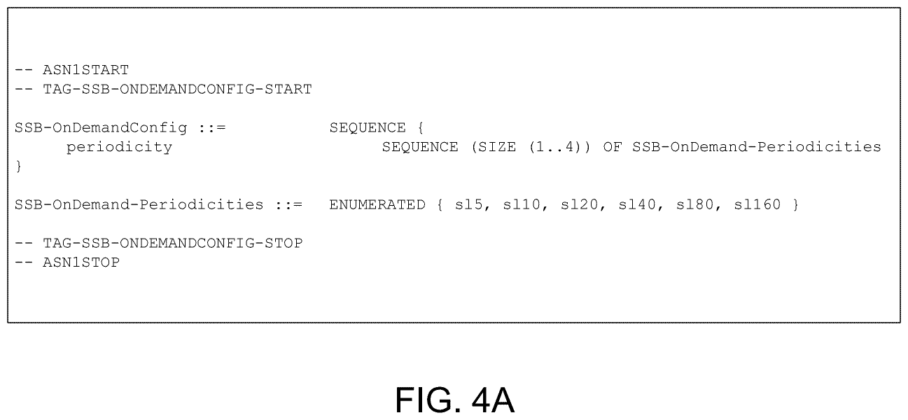

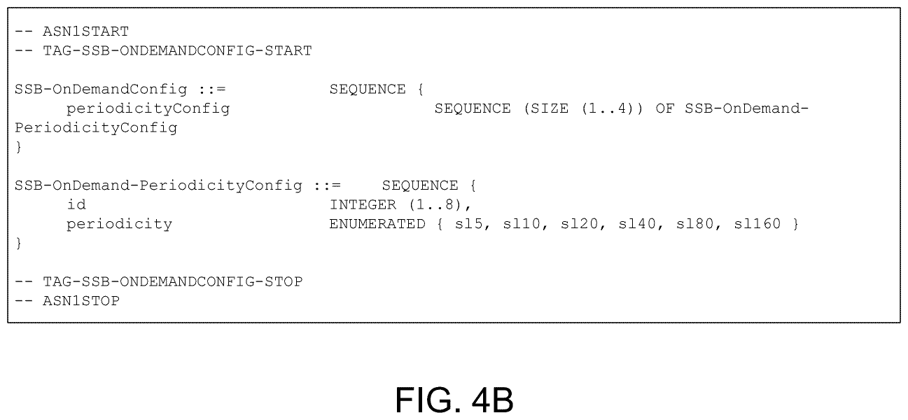

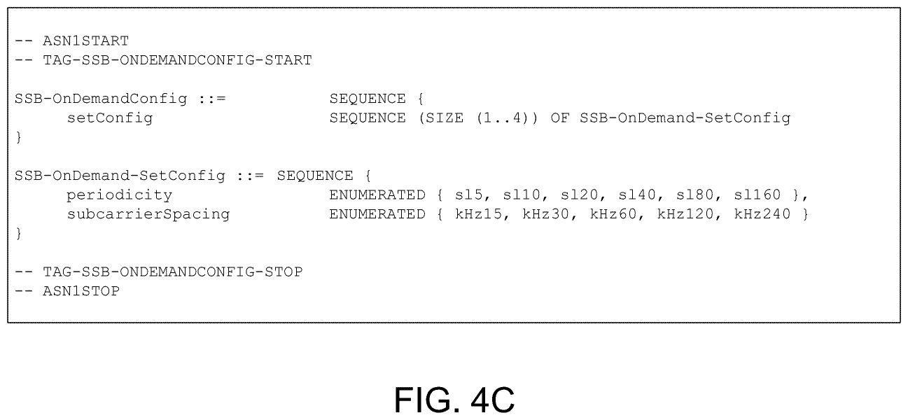

FIG. 4A illustrates an example of an ASN.1 structure for a configuration IE for on-demand SSB, in accordance with aspects of the present disclosure. The configuration IE may be used by the network (e.g., gNB) to configure the UE with up to 4 different candidate periodicities from of the set {5, 10, 20, 40, 80, 160} slots.

According to another example, an on-demand SSB configuration ID may be explicitly included with the periodicity value in the configuration, for example for a first periodicity value a first on-demand SSB configuration ID is explicitly configured, for a second periodicity value a second on-demand SSB configuration ID is explicitly configured. Note that these explicitly indicated on-demand SSB configuration IDs do not necessarily have to form subsequent numbers, e.g., the first periodicity value may be associated with on-demand SSB configuration ID_4, the second periodicity value may be associated with on-demand SSB configuration ID_2, etc. However, one ID should be associated with only one periodicity value, e.g., a configuration should not happen where two different periodicity values are associated with the same ID value. Beneficially, the explicit configuration allows more flexibility for the network configuration. An example configuration format is shown in FIG. 4B, where up to 4 different periodicities and corresponding IDs can be configured, where each ID can be chosen as an integer number from 1 to 8.

FIG. 4B illustrates an example of an ASN.1 structure for a configuration IE for on-demand SSB, in accordance with aspects of the present disclosure. The configuration IE may be used by the network (e.g., gNB) to configure the UE with up to 4 different candidate periodicities from of the set {5, 10, 20, 40, 80, 160} slots, and associate each of those candidate periodicities with an ID of an integer value from 1 to 8. Note that in the example of FIG. 4B, the network explicitly configures the on-demand SSB configuration ID associated with each periodicity value.

According to another example, a plurality of on-demand SSB parameters may form a parameter set, and an on-demand SSB configuration ID is associated with each such set. The on-demand SSB configuration ID may be derived from the order of the candidate values, such as the first periodicity value is associated with on-demand SSB configuration ID_1, the second periodicity value is associated with on-demand SSB configuration ID_2, etc.; alternatively, an on-demand SSB configuration ID associated with a parameter set may be explicitly included in the configuration.

FIG. 4C illustrates an example of an ASN.1 structure for a configuration IE for on-demand SSB, in accordance with aspects of the present disclosure. The configuration IE may be used by the network (e.g., gNB) to configure the UE with up to 4 parameter sets, each of which includes a periodicity value and a subcarrier spacing value. The different candidate periodicities are {5, 10, 20, 40, 80, 160} slots, and the different subcarrier spacings are {15, 30, 60, 120, 240} kHz.

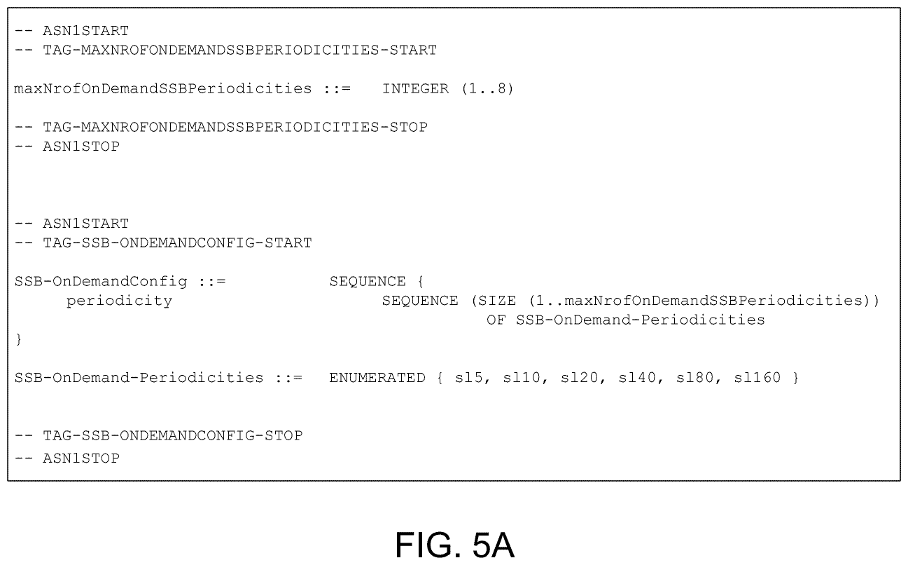

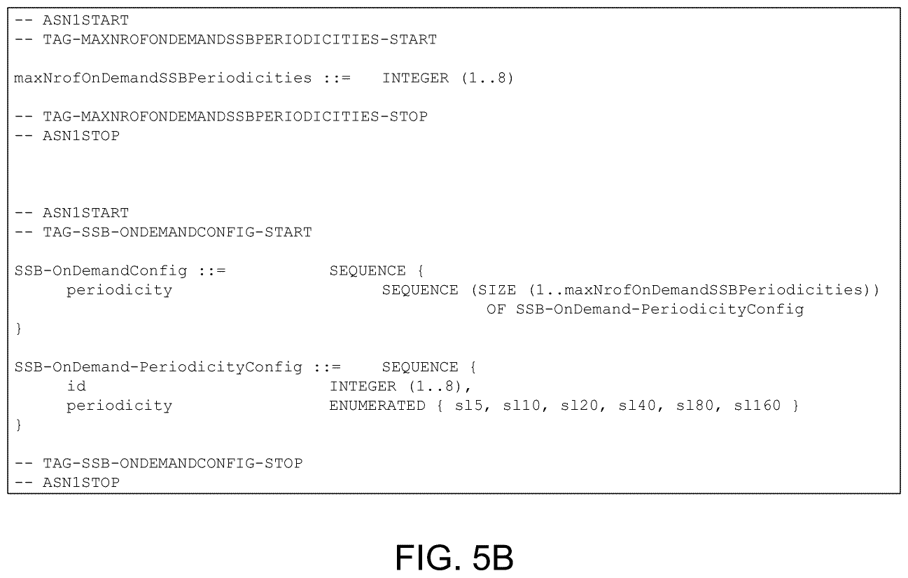

FIG. 5A illustrates an example of another ASN.1 structure for a configuration IE for on-demand SSB, in accordance with aspects of the present disclosure. The configuration IE may be used by the network (e.g., gNB) to configure the UE with up to a maximum number of different periodicities from of the set {5, 10, 20, 40, 80, 160} slots, where the maximum number of configurable periodicities is configurable with a value from the set {1, 2, . . . , 8}.

FIG. 5B illustrates an example of another ASN.1 structure for a configuration IE for on-demand SSB, in accordance with aspects of the present disclosure. The configuration IE may be used by the network (e.g., gNB) to configure the UE (e.g., via RRC signaling) with up to a maximum number of different periodicities from of the set {5, 10, 20, 40, 80, 160} slots, and associate each of those periodicities with an ID of an integer value from 1 to 8, where the maximum number of configurable periodicities is configurable with a value from the set {1, 2, . . . , 8}. Note that in the example of FIG. 5B, the network explicitly configures the on-demand SSB configuration ID associated with each periodicity value.

It will be understood that various aspects of the above described examples of configuration IEs may be combined to form a new configuration ID. For example, a parameter set configuration may be combined with an explicit indication of the configuration ID and/or may be combined with a configurable maximum number of values for the parameters included in the configuration IE. Still further, a configuration IE may include values for other parameters, e.g., DL transmit power, frequency domain position, time domain position, or another on-demand SSB parameter described herein.

According to an implementation of the first solution, a MAC-CE transmitted to at least a group of UEs in a cell (or specifically to all UEs in a cell) includes a selection ID that indicates an on-demand SSB configuration ID associated with a periodicity value. Specifically, the on-demand SSB configuration ID included in the MAC-CE corresponds to an implicit or explicit on-demand SSB configuration ID associated with a periodicity value in the RRC configuration.

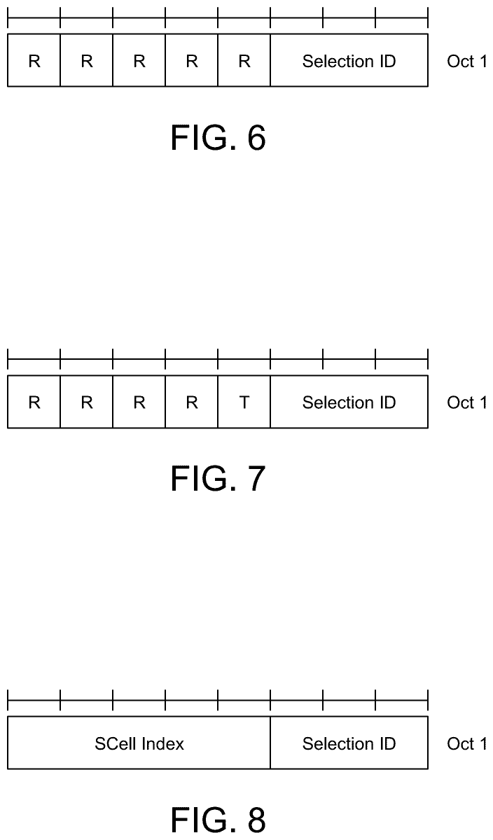

FIG. 6 illustrates an example of an octet of a MAC-CE including a selection ID field in accordance with aspects of the present disclosure. In the depicted example, the selection ID field in the MAC-CE is 3 bits wide, so that it can select one out of up to 8 configured values. Other fields in the octet may be reserved (“R”) or used for other purposes (see also other implementations).

According to an implementation of the first solution, the MAC-CE includes a field that indicates if the MAC-CE selects an on-demand SSB configuration ID from those configured by a group-common/cell-wide RRC configuration or from a UE-dedicated configuration, i.e., if the selection ID corresponds to an on-demand SSB configuration ID from those configured by a group-common/cell-wide RRC configuration or from a UE-dedicated configuration.

FIG. 7 illustrates an example of a MAC-CE including a selection ID field and a target field in accordance with aspects of the present disclosure. In the depicted example, the selection ID field in the MAC-CE is 3 bits wide, so that it can select one out of up to 8 configured values, and in addition a target (“T”) field that indicates whether the selection ID corresponds to an on-demand SSB configuration ID from those configured by: i) a group-common/cell-wide RRC configuration or ii) by a UE-dedicated configuration. Other fields in the octet may be reserved (“R”) or used for other purposes (see also other implementations).

According to an implementation of the first solution, the MAC-CE includes a cell ID to indicate for which cell a corresponding on-demand SSB configuration ID is valid. For example, the cell ID may be a physical cell ID, or an SCell index. According to a specific implementation, the MAC-CE includes a plurality of pairs, where each pair includes a cell ID and a corresponding selection ID.

FIG. 8 illustrates an example of a MAC-CE including a selection ID field and a SCell index field in accordance with aspects of the present disclosure. In the depicted example, the selection ID field in the MAC-CE is 3 bits wide, so that it can select one out of up to 8 configured values. Additionally, the MAC-CE comprises an SCell index field of length 5 bits that can indicate one out of up to 32 configured SCells. Other fields in the octet may be reserved (“R”) or used for other purposes (see also other implementations).

According to an implementation of the first solution, the order of selection IDs in a MAC-CE corresponds to the SCell index, e.g., a first MAC-CE selection ID corresponds to the first SCell configured to a UE, a second MAC-CE selection ID corresponds to the second SCell configured to a UE, and so forth. This is particularly applicable for a MAC-CE that is conveyed as a UE-dedicated message.

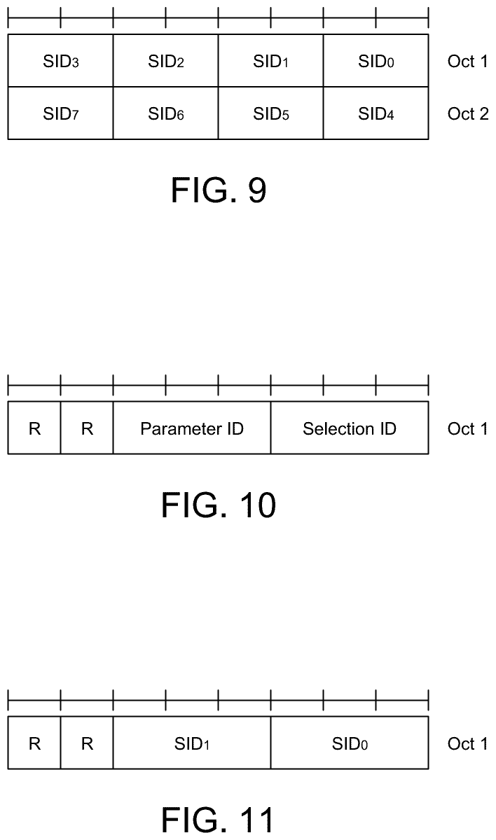

FIG. 9 illustrates an example of a MAC-CE including a plurality of selection ID fields, in accordance with aspects of the present disclosure, each of which is applicable per SCell. In the depicted example, there are 8 selection ID fields (SID_{c}) in the MAC-CE each 2 bits wide, so that each selection ID field can select one out of up to 4 configured values. The index c identifies an SCell, for example, the value c=0 identifies a first SCell, the value c=1 identifies a second SCell, etc.

According to an implementation of the first solution, one selection ID value that can be signaled in the MAC-CE corresponds to no selected value (e.g., periodicity), or equivalently disabling/deactivating on-demand SSB transmission. Accordingly, a UE detecting such a selection ID does not further (attempt to) receive on-demand SSBs. For example, if the selection ID field in the MAC-CE is 3 bits wide, selection ID values 1-7 correspond to on-demand SSB configuration IDs 1-7 (or 0-6, etc.), while selection ID value 0 (or 8) corresponds to no selected value, or equivalently disabling/deactivating on-demand SSB transmission.

According to an implementation of the first solution, a selection ID is associated with one or more of a parameter and a value. For example, in the case where the configuration includes multiple parameters for each of which multiple values are configured, the selection ID may contain information about the selected parameter as well as the selected value, e.g., “Parameter 1 Value 1” or “Parameter 2 Value 4”. According to a specific implementation, the position of the value implies the parameter number. For example, a first value field indicated in the MAC-CE is associated with a first parameter, and a second value field indicated in the MAC-CE is associated with a second parameter value.

FIG. 10 illustrates an example of a MAC-CE including a selection ID field and a parameter ID field in accordance with aspects of the present disclosure. In the depicted example, the parameter ID field and the selection ID field are each 3 bits wide, so that the parameter ID field can select one out of up to 8 parameters, and the selection ID field can select one out of up to 8 configured values.

FIG. 11 illustrates another example of a MAC-CE including a plurality of selection ID fields in accordance with aspects of the present disclosure. In the depicted example, the MAC-CE comprises two selection ID fields (SIDᵢ), each 3 bits wide, so that each selection ID field can select one out of up to 8 configured values. In some embodiments, the index i identifies a parameter, e.g., i=0 identifies a first parameter such as a periodicity, i=1 identifies a second parameter such as a transmit power.

According to an alternative implementation, the selection ID is associated with a parameter set of one or more of a parameter and a value. For example, in the case where the configuration includes multiple parameters for each of which multiple values are configured, a parameter set can include multiple parameters with one value each. For example, a first parameter set may include “Parameter 1 Value 1” and “Parameter 2 Value 4”, and is associated with selection ID_1.

Accordingly, different parameter sets may be employed (i.e., utilized), each of which is identified by a parameter set ID. The selection ID then indicates which of the parameter sets is to be applied. According to a specific implementation, the order of the parameter set implies the parameter set ID. The MAC-CE may employ the structure according to one of FIG. 6 to FIG. 9, where a selection ID (SID) is associated with a parameter set ID.

According to aspects of a second solution, a UE may have received one or both of a group-common/cell-wide RRC configuration and UE-dedicated RRC configuration, which may configure and associate different or identical indices with different periodicities. For example, the group-common/cell-wide RRC configuration may configure a first set of candidate values for a first set of one or more parameters, while the UE-dedicated RRC configuration may configure a second set of candidate values for a second set of one or more parameters. A UE may then determine whether a received MAC-CE message including an on-demand SSB configuration selection ID refers to a group-common/cell-wide RRC configuration or from a UE-dedicated configuration.

As used herein, a group-common RRC configuration refers to a configuration applied to a group of UEs, e.g., for more efficient use of network resources. Instead of configuring individual UEs with dedicated control signals, the network uses common control information that is broadcasted or multi-casted to a group of UEs. In certain embodiments, the group of UEs comprises all UEs in the cell. In such embodiments, the group-common configuration may be referred to as a cell-wide configuration; accordingly, the term “group-common/cell-wide RRC configuration” refers to a common configuration applied to a group of UEs, up to all UEs in the cell.

In contrast, the term “UE-dedicated RRC configuration” refers to an RRC configuration transmitted to a UE using dedicated control signaling. In certain embodiments, the same dedicated configuration may be given to multiple UEs.

The following enumerates examples of how a UE may determine whether to apply an on-demand SSB configuration IDs from a group-common/cell-wide RRC configuration or from a UE-dedicated configuration:

In some embodiments, the UE applies a value associated with an on-demand SSB configuration ID from a group-common/cell-wide RRC configuration, if the UE determines that the MAC-CE includes a field indicating that the on-demand SSB configuration ID is to be applied from a group-common/cell-wide RRC configuration.

Alternatively, or additionally, the UE may apply a value associated with an on-demand SSB configuration ID from the group-common/cell-wide RRC configuration, if the UE determines that the MAC-CE is included in a transport block that has been scheduled by a downlink control information (DCI), where the DCI indicates that the MAC-CE is associated with a group-common/cell-wide RRC configuration.

Alternatively, or additionally, the UE may apply a value associated with an on-demand SSB configuration ID from the group-common/cell-wide RRC configuration, if the UE determines that the MAC-CE is included in a transport block that has been scheduled by a DCI scrambled with a group/common RNTI. Examples for a group/common RNTI include the system information (SI) RNTI (SI-RNTI), the paging RNTI (P-RNTI), the multicast control channel (MCCH) RNTI (MCCH-RNTI), the paging early indication (PEI) RNTI (PEI-RNTI), and the group RNTI (G-RNTI).

In some embodiments, the UE applies a value associated with an on-demand SSB configuration ID from a UE-dedicated RRC configuration, if the UE determines that the MAC-CE includes a field indicating that the on-demand SSB configuration ID refers to a UE-dedicated RRC configuration.

Alternatively, or additionally, the UE may apply a value associated with an on-demand SSB configuration ID from the UE-dedicated RRC configuration, if the UE determines that the MAC-CE is included in a transport block that has been scheduled by a DCI where the DCI indicates that the MAC-CE is associated with a UE-dedicated RRC configuration.

Alternatively, or additionally, the UE may apply a value associated with an on-demand SSB configuration ID from the UE-dedicated RRC configuration, if the UE determines that the MAC-CE is included in a transport block that has been scheduled by a DCI scrambled with a UE-specific RNTI. Examples for a UE-specific RNTI include the cell RNTI (C-RNTI) and the temporary cell RNTI (TC-RNTI).

According to an implementation of the second solution, a UE that has not received a group-common/cell-wide RRC configuration for a serving cell ignores an on-demand SSB configuration IDs received from a MAC-CE, if the MAC-CE is determined to be associated with a group-common/cell-wide RRC configuration.

According to an implementation of the second solution, a UE that has not received a UE-dedicated RRC configuration for a serving cell ignores an on-demand SSB configuration IDs received from a MAC-CE if the MAC-CE is determined to be associated with a UE-dedicated RRC configuration.

According to an implementation of the second solution, a UE that has received a group-common/cell-wide RRC configuration as well as a UE-dedicated RRC configuration for a cell applies the latest on-demand SSB configuration IDs received by a MAC-CE according to whether the MAC-CE is determined to be associated with a group-common/cell-wide RRC configuration or with a UE-dedicated RRC configuration, respectively.

According to an implementation of the second solution, a UE determines that no hybrid automated repeat request (HARQ) feedback is to be transmitted by the UE for the MAC-CE in case that the MAC-CE is scheduled by a DCI scrambled with a group-common/system-wide RNTI, or if the MAC-CE is determined to refer to an on-demand SSB configuration from a group-common/cell-wide RRC configuration.

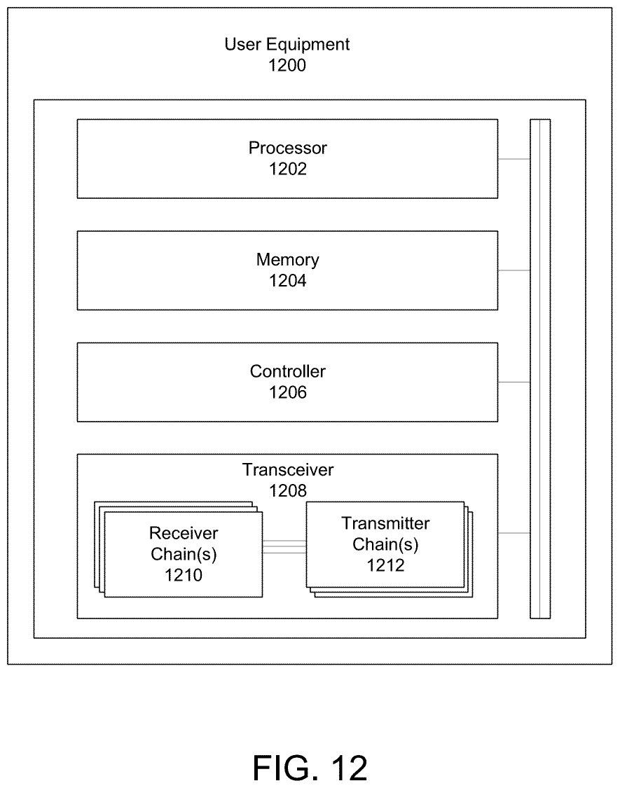

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a central processing unit (CPU), an ASIC, a field programmable gate array (FPGA), or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions that, when executed by the processor 1202, cause the UE 1200 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the UE functions described herein (e.g., executing, by the processor 1202, instructions stored in the memory 1204). Accordingly, the processor 1202 may support wireless communication at the UE 1200 in accordance with examples as disclosed herein. For example, the UE 1200 may be configured to support a means for receiving a SSB configuration comprising a set of one or more parameters, wherein a parameter of the set of one or more parameters is associated with a plurality of values.

In some embodiments, the SSB configuration is received in a RRC message from a primary cell. In other embodiments, the SSB configuration may be received in a RRC message from a secondary cell that is already activated. In certain embodiments, the SSB configuration comprises a group-common SSB configuration, or a cell-wide SSB configuration, or a UE-dedicated SSB configuration.

The UE 1200 may be configured to support a means for receiving a first message comprising at least one identifier (e.g., a selection ID). In some embodiments, the first message comprises a MAC-CE received from the primary cell.

The UE 1200 may be configured to support a means for determining a parameter and a value for the parameter based at least in part on the at least one identifier, where the value corresponds to one of the plurality of values. In some embodiments, the processor 1300 is configured to select the value from the plurality of values based on the determination. The UE 1200 may be configured to support a means for receiving an SSB transmission based at least in part on the determined parameter and the determined value for the determined parameter.

In some embodiments, the SSB configuration comprises a group-common SSB configuration, and the UE 1200 further receives a second SSB configuration comprising a UE-dedicated SSB configuration. In such embodiments, the UE 1200 may be configured to determine whether the at least one identifier corresponds to the group-common SSB configuration or to the UE-dedicated SSB configuration.

In certain embodiments, the first message includes a field that indicates that the at least one identifier corresponds to the group-common SSB configuration or to the UE-dedicated SSB configuration.

In certain embodiments, the UE 1200 is configured to receive DCI that schedules the first message, where the DCI comprises an indication that the first message is associated with the group-common SSB configuration or the UE-dedicated SSB configuration, wherein the at least one identifier is determined to correspond to the group-common SSB configuration or to the UE-dedicated SSB configuration based at least in part on the received DCI.

In certain embodiments, the UE 1200 is configured to: A) receive DCI that schedules the first message; and B) determine that the at least one identifier corresponds to the group-common SSB configuration in response to the DCI being associated with a group-common RNTI, or to the at least one identifier corresponds to the UE-dedicated SSB configuration in response to the DCI being associated with a UE-specific RNTI.

In some embodiments, the first message (e.g., MAC-CE) indicates a serving cell ID of a SCell, wherein the parameter and the value for the parameter are applicable to the SCell. In certain embodiments, the serving cell ID is one of a physical cell ID, a cell index, or an SCell index.

In certain embodiments, the UE 1200 is configured to determine the serving cell ID based at least in part on a position of the at least one identifier in the first message, e.g., where a first position in the first message corresponds to a first serving cell ID, a second position in the first message corresponds to a second serving cell ID, etc.

The controller 1206 may manage input and output signals for the UE 1200. The controller 1206 may also manage peripherals not integrated into the UE 1200. In some implementations, the controller 1206 may utilize an operating system (OS) such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receiving the signal over the air or wireless medium. The receiver chain 1210 may include at least one amplifier (e.g., a low-noise amplifier (LNA)) configured to amplify the received signal. The receiver chain 1210 may include at least one demodulator configured to demodulate the received signal and obtain the transmitted data by reversing the modulation technique applied during transmission of the signal. The receiver chain 1210 may include at least one decoder for decoding/processing the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

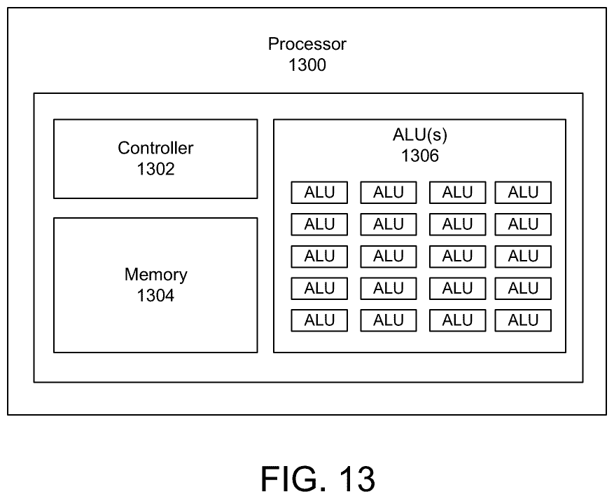

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory address of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein.

Additionally, or alternatively, the controller 1302 may be configured to manage flow of data within the processor 1300. The controller 1302 may be configured to control transfer of data between registers, arithmetic logic units (ALUs), and other functional units of the processor 1300.

The memory 1304 may include one or more caches (e.g., memory local to or included in the processor 1300 or other memory, such RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, the controller 1302, and the memory 1304 may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

In various implementations, the processor 1300 may support the functions of a UE, in accordance with examples as disclosed herein. For example, the processor 1300 may be configured to support a means for receiving a SSB configuration comprising a set of one or more parameters, wherein a parameter of the set of one or more parameters is associated with a plurality of values.

In some embodiments, the SSB configuration is received in a RRC message from a primary cell. In other embodiments, the SSB configuration may be received in a RRC message from a secondary cell that is already activated. In certain embodiments, the SSB configuration comprises a group-common SSB configuration, or a cell-wide SSB configuration, or a UE-dedicated SSB configuration.

The processor 1300 may be configured to support a means for receiving a first message comprising at least one identifier (e.g., a selection ID). In some embodiments, the first message comprises a MAC-CE received from the primary cell.

The processor 1300 may be configured to support a means for determining a parameter and a value for the parameter based at least in part on the at least one identifier, wherein the value corresponds to one of the plurality of values. In some embodiments, the processor 1300 is configured to select the value from the plurality of values based on the determination. The processor 1300 may be configured to support a means for receiving an SSB transmission based at least in part on the determined parameter and the determined value for the determined parameter.

In some embodiments, the SSB configuration comprises a group-common SSB configuration, and the processor 1300 further receives a second SSB configuration comprising a UE-dedicated SSB configuration. In such embodiments, the processor 1300 may be configured to determine whether the at least one identifier corresponds to the group-common SSB configuration or to the UE-dedicated SSB configuration.

In certain embodiments, the first message includes a field that indicates that the at least one identifier corresponds to the group-common SSB configuration or to the UE-dedicated SSB configuration.

In certain embodiments, the processor 1300 is configured to receive DCI that schedules the first message, where the DCI comprises an indication that the first message is associated with the group-common SSB configuration or the UE-dedicated SSB configuration, wherein the at least one identifier is determined to correspond to the group-common SSB configuration or to the UE-dedicated SSB configuration based at least in part on the received DCI.

In certain embodiments, the processor 1300 is configured to: A) receive DCI that schedules the first message; and B) determine that the at least one identifier corresponds to the group-common SSB configuration in response to the DCI being associated with a group-common RNTI, or to the at least one identifier corresponds to the UE-dedicated SSB configuration in response to the DCI being associated with a UE-specific RNTI.

In some embodiments, the first message (e.g., MAC-CE) indicates a serving cell ID of a SCell, wherein the parameter and the value for the parameter are applicable to the SCell. In certain embodiments, the serving cell ID is one of a physical cell ID, a cell index, or an SCell index.

In certain embodiments, the processor 1300 is configured to determine the serving cell ID based at least in part on a position of the at least one identifier in the first message, e.g., where a first position in the first message corresponds to a first serving cell ID, a second position in the first message corresponds to a second serving cell ID, etc.

In various implementations, the processor 1300 may support the functions of a base station, in accordance with examples as disclosed herein. For example, the processor 1300 may be configured to support a means for transmitting a SSB configuration comprising a set of one or more parameters, where a parameter of the set of one or more parameters is associated with a plurality of values.

In some embodiments, the SSB configuration is transmitted in a RRC message. In some embodiments, the SSB configuration comprises a group-common SSB configuration, or a cell-wide SSB configuration, or a UE-dedicated SSB configuration.

The processor 1300 may be configured to support a means for determining, for a serving cell, a parameter and a value for the parameter, wherein the value corresponds to one of the plurality of values.

The processor 1300 may be configured to support a means for transmitting a first message comprising at least one identifier (e.g., selection ID) to a UE, wherein the at least one identifier identifier indicates the value for the parameter. In some embodiments, the first message comprises a MAC-CE.

In some embodiments, the SSB configuration comprises a group-common SSB configuration, and the processor 1300 is configured to: A) transmit a second SSB configuration comprising a UE-dedicated SSB configuration; and B) indicate whether the at least one identifier corresponds to the group-common SSB configuration or to the UE-dedicated SSB configuration.

In certain embodiments, the first message includes a field that indicates whether the at least one identifier corresponds to the group-common SSB configuration or to the UE-dedicated SSB configuration.

In certain embodiments, the processor 1300 is configured to transmit DCI that schedules the first message, where the DCI comprises an indication that the first message is associated with the group-common SSB configuration or the UE-dedicated SSB configuration, wherein the at least one identifier is determined to correspond to the group-common SSB configuration or to the UE-dedicated SSB configuration based at least in part on the received DCI.

In certain embodiments, the at least one processor is configured to cause the base station to transmit DCI that schedules the first message, the DCI being associated with a group-common RNTI or a UE-specific RNTI. In such embodiments, the group-common RNTI indicates that the at least one identifier corresponds to the group-common SSB configuration, and the UE-specific RNTI indicates that the at least one identifier corresponds to the UE-dedicated SSB configuration.

In some embodiments, the first message indicates a serving cell ID of the serving cell for which the respective parameter and the respective value apply. In certain embodiments, the serving cell ID is one of a physical cell ID, a cell index, or a SCell index.

In certain embodiments, the processor 1300 is configured to indicate the serving cell ID based at least in part on a position of the at least one identifier in the first message, e.g., where a first position in the first message corresponds to a first serving cell ID, a second position in the first message corresponds to a second serving cell ID, etc.

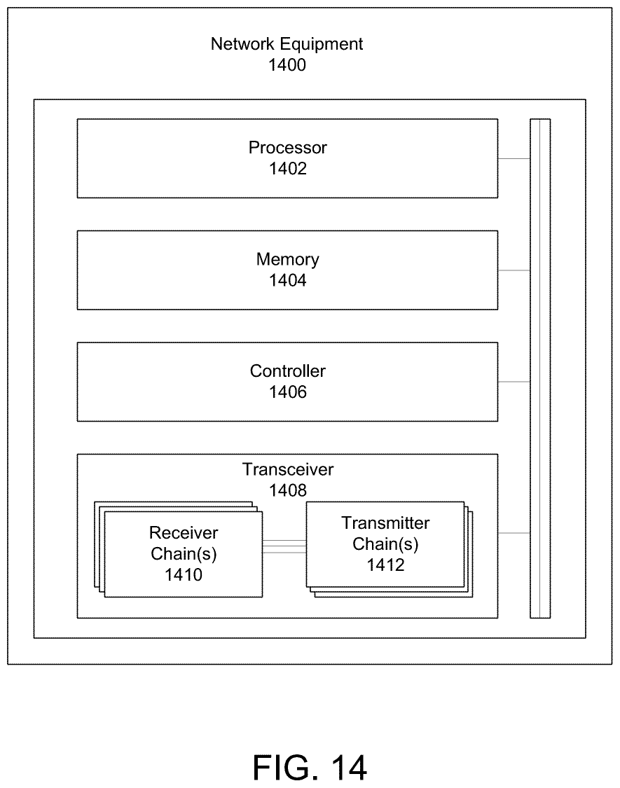

FIG. 14 illustrates an example of an NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more base station functions as described herein (e.g., executing, by the processor 1402, instructions stored in the memory 1404). Accordingly, the processor 1402 may support the communication at the NE 1400 in accordance with examples as disclosed herein.

For example, the NE 1400 may be configured to support a means for transmitting a SSB configuration comprising a set of one or more parameters, wherein a parameter of the set of one or more parameters is associated with a plurality of values. In some embodiments, the SSB configuration is transmitted in a RRC message. In some embodiments, the SSB configuration comprises a group-common SSB configuration, or a cell-wide SSB configuration, or a UE-dedicated SSB configuration.

The NE 1400 may be configured to support a means for determining, for a serving cell, a parameter and a value for the parameter, wherein the value corresponds to one of the plurality of values.

The NE 1400 may be configured to support a means for transmitting a first message comprising at least one identifier (e.g., selection ID) to a UE, wherein the at least one identifier indicates the value for the parameter. In some embodiments, the first message comprises a MAC-CE.

In some embodiments, the SSB configuration comprises a group-common SSB configuration, and the NE 1400 is configured to: A) transmit a second SSB configuration comprising a UE-dedicated SSB configuration; and B) indicate whether the at least one identifier corresponds to the group-common SSB configuration or to the UE-dedicated SSB configuration.

In certain embodiments, the first message comprises a field that indicates whether the at least one identifier corresponds to the group-common SSB configuration or to the UE-dedicated SSB configuration.

In certain embodiments, the NE 1400 is configured to transmit DCI that schedules the first message, where the DCI comprises an indication that the first message is associated with the group-common SSB configuration or the UE-dedicated SSB configuration, wherein the at least one identifier is determined to correspond to the group-common SSB configuration or to the UE-dedicated SSB configuration based at least in part on the received DCI.

In certain embodiments, the NE 1400 is configured to transmit DCI that schedules the first message, the DCI being associated with a group-common RNTI or a UE-specific RNTI. In such embodiments, the group-common RNTI indicates that the at least one identifier corresponds to the group-common SSB configuration, and the UE-specific RNTI indicates that the at least one identifier corresponds to the UE-dedicated SSB configuration.

In some embodiments, the first message indicates a serving cell ID of the serving cell for which the respective parameter and the respective value apply. In certain embodiments, the serving cell ID is one of a physical cell ID, a cell index, or a SCell index.

In certain embodiments, the NE 1400 is configured to indicate the serving cell ID based at least in part on a position of the at least one identifier in the first message, e.g., where a first position in the first message corresponds to a first serving cell ID, a second position in the first message corresponds to a second serving cell ID, etc.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas for receiving the signal over the air or wireless medium. The receiver chain 1410 may include at least one amplifier (e.g., a low-noise amplifier (LNA)) configured to amplify the received signal. The receiver chain 1410 may include at least one demodulator configured to demodulate the received signal and obtain the transmitted data by reversing the modulation technique applied during transmission of the signal. The receiver chain 1410 may include at least one decoder for decoding/processing the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

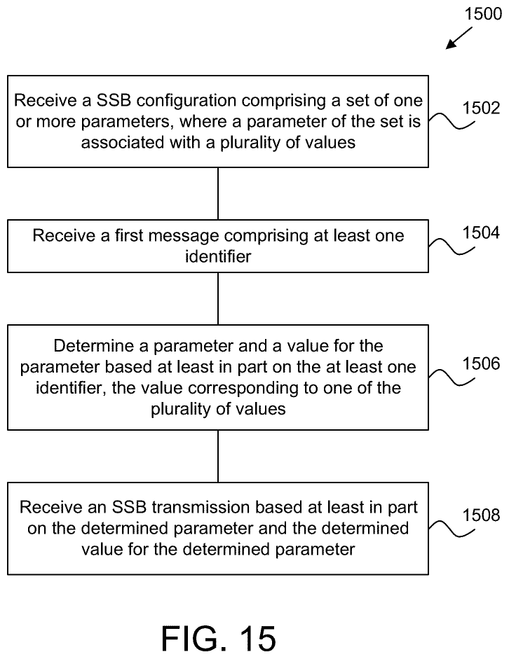

FIG. 15 depicts one embodiment of a method 1500 in accordance with aspects of the present disclosure. In various embodiments, the operations of the method 1500 may be implemented by a UE, as described herein. In some implementations, the UE may execute a set of instructions to control the function elements of the UE to perform the described functions.

At step 1502, the method 1500 may include receiving a SSB configuration comprising a set of one or more parameters, wherein a parameter of the set of one or more parameters is associated with a plurality of values. The operations of step 1502 may be performed in accordance with examples as described herein. In some implementations, aspects of the operations of step 1502 may be performed by a UE, as described with reference to FIG. 12.

At step 1504, the method 1500 may include receiving a first message comprising at least one identifier. The operations of step 1504 may be performed in accordance with examples as described herein. In some implementations, aspects of the operations of step 1504 may be performed by a UE, as described with reference to FIG. 12.

At step 1506, the method 1500 may include determining a set of one or more parameters, wherein a parameter of the set of one or more parameters is associated with a plurality of values. The operations of step 1506 may be performed in accordance with examples as described herein. In some implementations, aspects of the operations of step 1506 may be performed by a UE, as described with reference to FIG. 12.

At step 1508, the method 1500 may include receiving an SSB transmission based at least in part on the determined parameter and the determined value for the determined parameter. The operations of step 1508 may be performed in accordance with examples as described herein. In some implementations, aspects of the operations of step 1508 may be performed by a UE, as described with reference to FIG. 12.

It should be noted that the method 1500 described herein describes one possible implementation, and that the operations and the steps may be rearranged or otherwise modified and that other implementations are possible.

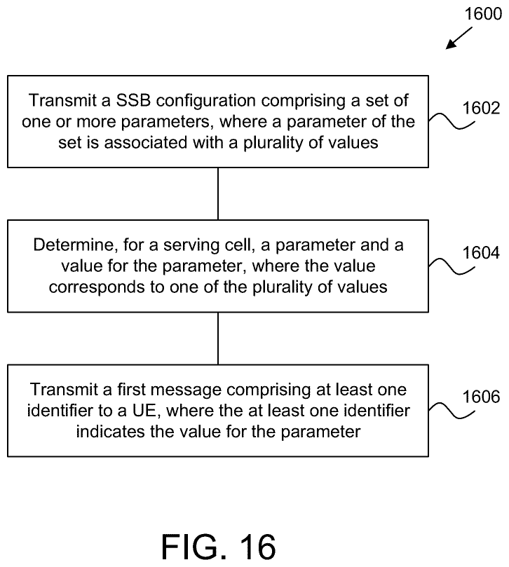

FIG. 16 depicts one embodiment of a method 1600 in accordance with aspects of the present disclosure. In various embodiments, the operations of the method 1600 may be implemented by a base station, as described herein. In some implementations, the base station may execute a set of instructions to control the function elements of the base station to perform the described functions.

At step 1602, the method 1600 may include transmitting a SSB configuration comprising a set of one or more parameters, wherein a parameter of the set of one or more parameters is associated with a plurality of values. The operations of step 1602 may be performed in accordance with examples as described herein. In some implementations, aspects of the operations of step 1602 may be performed by an NE, as described with reference to FIG. 14.

At step 1604, the method 1600 may include determining, for a serving cell, a parameter and a value for the parameter, wherein the value corresponds to one of the plurality of values. The operations of step 1604 may be performed in accordance with examples as described herein. In some implementations, aspects of the operations of step 1604 may be performed by an NE, as described with reference to FIG. 14.

At step 1606, the method 1600 may include transmitting a first message comprising at least one identifier to a UE, wherein the at least one identifier indicates the value for the parameter. The operations of step 1606 may be performed in accordance with examples as described herein. In some implementations, aspects of the operations of step 1606 may be performed by a NE, as described with reference to FIG. 14.

It should be noted that the method 1600 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a synchronization signal block (SSB) configuration comprising a set of one or more parameters, wherein a parameter of the set of one or more parameters is associated with a plurality of values;
receive a first message comprising at least one identifier;
determine a parameter and a value for the parameter based at least in part on
the at least one identifier, wherein the value corresponds to one of the plurality of values; and
receive an SSB transmission based at least in part on the determined parameter and the determined value for the determined parameter.

2. The UE of claim 1, wherein the SSB configuration is received in a radio resource control (RRC) message from a primary cell, and wherein the first message comprises a medium access control (MAC) control element (MAC-CE) received from the primary cell.

3. The UE of claim 1, wherein the SSB configuration comprises a group-common SSB configuration, or a cell-wide SSB configuration, or a UE-dedicated SSB configuration.

4. The UE of claim 1, wherein the SSB configuration comprises a group-common SSB configuration, and wherein the at least one processor is configured to cause the UE to:
receive a second SSB configuration comprising a UE-dedicated SSB configuration; and
determine whether the at least one identifier corresponds to the group-common SSB configuration or to the UE-dedicated SSB configuration.

5. The UE of claim 4, wherein the first message includes a field that indicates that the at least one identifier corresponds to the group-common SSB configuration or to the UE-dedicated SSB configuration.

6. The UE of claim 4, wherein the at least one processor is configured to cause the UE to:
receive downlink control information (DCI) that schedules the first message, wherein the DCI comprises an indication that the first message is associated with the group-common SSB configuration or the UE-dedicated SSB configuration,
wherein the at least one identifier is determined to correspond to the group-common SSB configuration or to the UE-dedicated SSB configuration based at least in part on the received DCI.

7. The UE of claim 4, wherein the at least one processor is configured to cause the UE to:
receive downlink control information (DCI) that schedules the first message;
determine that the at least one identifier corresponds to the group-common SSB configuration in response to the DCI being associated with a group-common radio network temporary identifier (RNTI), or to the UE-dedicated SSB configuration in response to the DCI being associated with a UE-specific RNTI.

8. The UE of claim 1, wherein the first message indicates a serving cell identifier of a secondary cell, wherein the parameter and the value for the parameter are applicable for the secondary cell, and wherein the serving cell identifier is one of a physical cell identifier, a cell index, or a secondary cell index.

9. The UE of claim 8, wherein the at least one processor is configured to cause the UE to determine the serving cell identifier based at least in part on a position of the at least one identifier in the first message, and wherein a first position in the first message corresponds to a first serving cell identifier, and a second position in the first message corresponds to a second serving cell identifier.

10. A processor for wireless communication, comprising:
at least one controller coupled with at least one memory and configured to cause the processor to:
receive a synchronization signal block (SSB) configuration comprising a set of one or more parameters, wherein a parameter of the set of one or more parameters is associated with a plurality of values;
receive a first message comprising at least one identifier;
determine a parameter and a value for the parameter based at least in part on the at least one identifier, wherein the value corresponds to one of the plurality of values; and
receive an SSB transmission based at least in part on the determined parameter and the determined value for the determined parameter.

11. A base station for wireless communication, comprising:
at least one memory; and
at least one processor coupled with the at least one memory and configured to cause the base station to:
transmit a synchronization signal block (SSB) configuration comprising a set of one or more parameters, wherein a parameter of the set of one or more parameters is associated with a plurality of values;
determine, for a serving cell, a parameter and a value for the parameter, wherein the value corresponds to one of the plurality of values; and
transmit a first message comprising at least one identifier to a user equipment (UE), wherein the at least one identifier indicates the value for the parameter.

12. The base station of claim 11, wherein the SSB configuration is transmitted in a radio resource control (RRC) message, and wherein the first message comprises a medium access control (MAC) control element (MAC-CE).

13. The base station of claim 11, wherein the SSB configuration comprises a group-common SSB configuration, or a cell-wide SSB configuration, or a UE-dedicated SSB configuration.

14. The base station of claim 11, wherein the SSB configuration comprises a group-common SSB configuration, and wherein the at least one processor is configured to cause the base station to:
transmit a second SSB configuration comprising a UE-dedicated SSB configuration; and
indicate whether the at least one identifier corresponds to the group-common SSB configuration or to the UE-dedicated SSB configuration.

15. The base station of claim 14, wherein the first message includes a field that indicates whether the at least one identifier corresponds to the group-common SSB configuration or to the UE-dedicated SSB configuration.

16. The base station of claim 14, wherein the at least one processor is configured to cause the base station to:
transmit downlink control information (DCI) that schedules the first message,
wherein the DCI comprises an indication that the first message is associated with the group-common SSB configuration or the UE-dedicated SSB configuration,
wherein the at least one identifier is determined to correspond to the group-common SSB configuration or to the UE-dedicated SSB configuration based at least in part on the DCI.

17. The base station of claim 14, wherein the at least one processor is configured to cause the base station to:
transmit downlink control information (DCI) that schedules the first message, the DCI being associated with a group-common radio network temporary identifier (RNTI) or a UE-specific RNTI,
wherein the group-common RNTI indicates that the at least one identifier corresponds to the group-common SSB configuration, and
wherein the UE-specific RNTI indicates that the at least one identifier corresponds to the UE-dedicated SSB configuration.

18. The base station of claim 11, wherein the first message indicates a serving cell identifier of the serving cell for which the respective parameter and the respective value apply, and wherein the serving cell identifier is one of a physical cell identifier, a cell index, or a secondary cell index.

19. The base station of claim 18, wherein the at least one processor is configured to cause the base station to indicate the serving cell identifier based at least in part on a position of the at least one identifier in the first message, and wherein a first position in the first message corresponds to a first serving cell identifier, and a second position in the first message corresponds to a second serving cell identifier.

20. A method performed by a base station, the method comprising:
transmitting a synchronization signal block (SSB) configuration comprising a set of one or more parameters, wherein a parameter of the set of one or more parameters is associated with a plurality of values;
determining, for a serving cell, a parameter and a value for the parameter, wherein the value corresponds to one of the plurality of values; and
transmitting a first message comprising at least one identifier to a user equipment (UE), wherein the at least one identifier indicates the value for the parameter.
